(19) United States
(12) Patent Application Publication
(10) Pub. No.: US 2015/0165810 A1
(43) Pub. Date: Jun. 18, 2015

(54) METHOD AND DOCUMENT

(71) Applicant: Document Management Solutions Limited, High Ongar (GB)

(72) Inventor: Robert Morris, Caerphilly (GB)

(21) Appl. No.: 14/568,037

(22) Filed: Dec. 11, 2014

(30) Foreign Application Priority Data
Dec. 13, 2013 (GB) 1322123.9

(51) Int. Cl. B42D 15/08; B05D 1/36; C09J 5/00

(52) U.S. Cl. CPC B42D 15/08; C09J 5/00; B05D 1/36

(57) ABSTRACT

A blank form for a mailing document is provided, the form comprising a paper substrate having a first border area and a second border area; adhesive located in one or both of the first border area and the second border area so positioned that when the form is folded the first border area contacts and bonds to the second border area; and wherein the form further comprises a releasable panel.

### INCORPORATION BY REFERENCE TO RELATED APPLICATION

Any and all priority claims identified in the Application Data Sheet, or any correction thereto, are hereby incorporated by reference under 37 CFR 1.57. This application claims the benefit of Patent Appl. No. GB 1322123.9 filed 13 Dec. 2013. The aforementioned application is incorporated by reference herein in its entirety, and is hereby expressly made a part of this specification.

### FIELD

A blank form for a document and a method of making such a form are provided. It is particularly applicable to a mailing document which does not require an envelope.

### BACKGROUND

Mailing documents are traditionally sold as flat blank forms and text is printed on one or both faces. The document is then folded and sealed at its borders in such a way that any confidential text is inside, out of view, and the name and address of the recipient is either on the outside or otherwise visible through a clear window. Thus the mailing document provides an integral envelope and letter combination, and is commonly known as a “one-piece mailer”.

For the purpose of sealing such documents, narrow strips of a thin layer of adhesive are laid down around the periphery of the document in a suitable pattern so that when the document is folded, opposing edges bond together to seal the document. The adhesive may be one which seals by contact, by pressure, by heat or by other means.

Traditionally the adhesive bonds permanently so that the document seals irreversibly to maintain the confidentiality of the information inside. Such mailers are described in WO 00/07825 and UK patent application no. 1308285.4. In these mailers a dry non-tacky contact adhesive is used. The contact adhesive can be selected such that the user can seal the mailer in a permanent manner using only finger pressure. Such use of a contact adhesive is also described in U.S. Pat. No. 3,476,307. Typically perforations are built into the document a predetermined distance from the edges, inside the adhesive strips, so that the sealed edges can be torn off to open the document to read the text inside.

Such mailing documents are used for communicating confidential information, such as details of an employee's pay, or bank card pin numbers. The printing, folding and sealing steps can be automated without human intervention. The need to tear off the edges to open the document makes it clear to a recipient if it has been opened or tampered with.

However tearing off the edges is an unsatisfactory way of opening documents since it is slow, produces waste which can be a nuisance, for example making a post desk untidy, and the opened document has ragged edges and is not a standard size for documents, which makes it unsatisfactory for further processing such as filing or scanning. In addition, tearing of the edges cannot always be done cleanly and can result in damage to the body of the document. For these reasons such one-piece mailing documents are not widely used other than for security applications.

A one-piece mailing document which can be opened more easily is known from GB 2475092, which describes a mailing document with a reversible seal which can be peeled open so that the opened document is full standard size and has clean smooth edges. However such a document can be opened by a third party and might be resealed without the intended recipient knowing that it has been tampered with, because peeling apart the seal leaves adhesive on both opposing surfaces. This presents a security issue since the intended recipient cannot tell whether the document has been opened and resealed. To avoid this lack of security, slits are incorporated in the edges of the blank form to cause the paper to tear and/or layers to separate when the seal is peeled apart so that a recipient can see that the document has been opened and resealed.

These slits are complex to insert during manufacture and add to the cost of the document. They also mean that the opened document is damaged even when opened by the intended recipient.

### SUMMARY

New forms of mailing documents are provided. In one aspect it proposes a mailing document which can be opened in a different manner. This alternative mailing document, in broad contrast to those made in accordance with WO 00/07825, can be opened by the recipient without damaging it, without the need to tear off edges and is cheaper and simpler to manufacture.

In another aspect a mailing document with an alternative security feature is provided.

According to one aspect, there is provided a blank form for a mailing document, the form comprising: a paper substrate having a first border area and a second border area; adhesive located in one or both of the first area and the second area so positioned that when the form is folded the first area contacts and bonds to the second area; and wherein the form further comprises a releasable panel, which is preferably manually releasable.

The releasable panel preferably has perforations around three sides within the border area so that the panel can be released to allow the content of the form to be viewed. The perforations are advantageously designed so that the panel can be separated from the border area on at least three sides relatively easily by hand without tearing or otherwise damaging the paper substrate.

At least one corner of the panel may be rounded or curved to facilitate easy separation without tearing the paper substrate itself.

The perforations are preferably arranged so that the separated edges of the panel and the form are relatively smooth, in contrast to the rough edge usually resulting from common perforations used for tear off strips. The preferred perforations are formed by making cuts in the form separated by ties which are shorter than the cuts. In one example these cuts would be formed 5 to one inch (2.54 cm) in contrast to the microperforations used traditionally for tear off strips which have 24 to 48 cuts to one inch.

In one embodiment each of the cuts would typically be 5-7 mm long and separated by a tie of 1 mm or less, preferably between ¼ mm and ¾mm. However the preferred cut-tie ratio depends on the characteristics of the substrate, in particular the weight of the paper from which the document is formed. Lighter, i.e. thinner, paper will usually require more substantial ties, i.e. towards the upper end of the range. Some experimentation to determine optimum cut lengths and cut-tie ratios for particular paper and applications would be expected, with the aim of a form in which the perforations separating the pull out panel are relatively unnoticeable in the sealed form and the edges of the panel when released or detached are relatively smooth.

Different lengths of cuts and ties may be used in different sections of the same form depending upon the application.

The releasable panel may optionally be removable from the sealed form by providing perforations along a fourth side. The fourth side may comprise perforations which are less easily released than the other three sides so that the user has the choice of detaching the panel completely or not.

Alternatively the releasable panel may be arranged to be released along three sides and remain attached to the form along the fourth side so that the form remains in one piece.

The adhesive may form a permanent irreversible bond or a reversible one, such as by use of a cohesive which bonds only with more cohesive. It may be a pressure seal adhesive sealable by machine pressure or a contact adhesive sealable by hand pressure.

A barrier layer may be interposed between the paper substrate and the cohesive in the first area, so that the cohesive in the first area is not in direct contact with the surface of the paper, and the cohesive in the second area is in direct contact with the surface of the paper.

The barrier layer may be varnish or liquid silicone and may be applied in one or more layers by a printing process and dried or otherwise cured, e.g. by UV light. The cohesive layers may also be applied by a printing process in thin, non-tacky layers.

In this way the sealed form may optionally be peeled open but cannot easily be re-sealed because the cohesive on the barrier layer is removed by the opening process.

Preferably the releasable panel comprises a major portion of one of the first and second parts of the form. That is to say that the perforations are located relatively close to or adjacent the cohesive coated border areas so that when the panel is released, substantially the whole of the inside of the form can be viewed.

According to another aspect, there is provided a method of making a blank form, the method comprising applying adhesive to a paper substrate in a border region along outside edges of the paper substrate and forming a manually releasable, or optionally removable, panel in the substrate.

Cohesive forms a bond or seal with itself but does not easily or permanently bond with non-absorbent materials. In a sufficiently thin layer it is generally non-tacky, so that the blank forms can be stacked, stored and printed on without sticking to each other or to other materials. However when the form is folded so that the cohesive on one part contacts cohesive in another part, and pressure is applied, then the contacting pieces of cohesive bind to each other to seal the document. Depending on the characteristics of the adhesive/cohesive and the pressure applied, the resultant seal may be permanent, so that the forms cannot be peeled open without damaging the substrate, or the seal may be non-permanent so that the form can be peeled open without damage to the substrate.

A non-permanent seal could also be made to be re-sealable for certain applications. Generally with cohesive a seal will be re-sealable if, when the seal is peeled apart, sufficient cohesive remains on both parts of the form. Using a barrier layer such as varnish decreases the porosity of the paper substrate so that the cohesive peels more easily off the varnished surface than from the paper substrate so the opened document cannot be re-sealed.

For security reasons, if confidential information is to be contained in the document then it is preferably sealed substantially around the whole edge. However smaller sections of sealing would suffice for other applications, for example for greetings correspondence, advertisements, promotional material, tokens, vouchers or inserts which can be mailed as part of the document. Such items could be included in the mailing document as the part of the resealable or removable panel or could be attached to the body of the document by adhesive or cohesive with or without a barrier layer on one or two sides. Alternatively such items could be enclosed in the document as a loose unattached insert.

The first and second parts of the form may each be one half of the blank in a traditional “V” fold document, or may be one third of the blank in either a “C” or “Z” fold document.

A form with a releasable panel has advantages because when the panel is removed the remainder of the form has a double thickness border which gives it more strength and resiliency to bending or tearing. Thus effectively thinner, i.e. lighter weight, paper may be used for the substrate with attendant cost savings. The stronger border is also better suited for storage in a ring binder because the necessary punched holes will be better supported.

According to yet another aspect, there is provided a blank form for a mailing document the form comprising a paper substrate having a first part and a second part, each having a border region and a pattern of cohesive located in each border region, and a barrier layer in the first part interposed between the paper substrate and the cohesive pattern so that in the first part the cohesive is not in direct contact with the surface of the paper, and in the second part the cohesive is in direct contact with the surface of the paper, wherein the cohesive is of a contrasting colour compared to the paper substrate, and wherein at least one hole is located in the border region of one of the second part so that the contrasting colour is visible in the hole when the document is sealed.

This provides additional security for confidential uses since if the sealed document is peeled open the cohesive on top of the barrier layer is removed and transferred to the other part of the form and if an attempt is made to re-seal the document (such as by manual application of more adhesive) the contrasting colour will no longer be visible through the hole or holes and the recipient will be alerted that the security of the form has been breached.

### DESCRIPTION OF THE DRAWINGS

For a better understanding of the present invention, and to show how the same may be carried into effect, reference will now be made to the accompanying drawings, in which:

FIG. 1 is a plan view of one embodiment of a blank form according to an embodiment;

FIG. 2 is a plan view of a blank form according to another embodiment;

FIG. 3a is a plan view of the form of FIG. 1 or 2 folded and sealed;

FIG. 3b is a plan view of the form of FIG. 3a partially opened;

FIG. 4 is a plan view of the form of FIGS. 3a and 3b opened after sealing; and

FIG. 5 is a plan view of a blank form according to another embodiment.

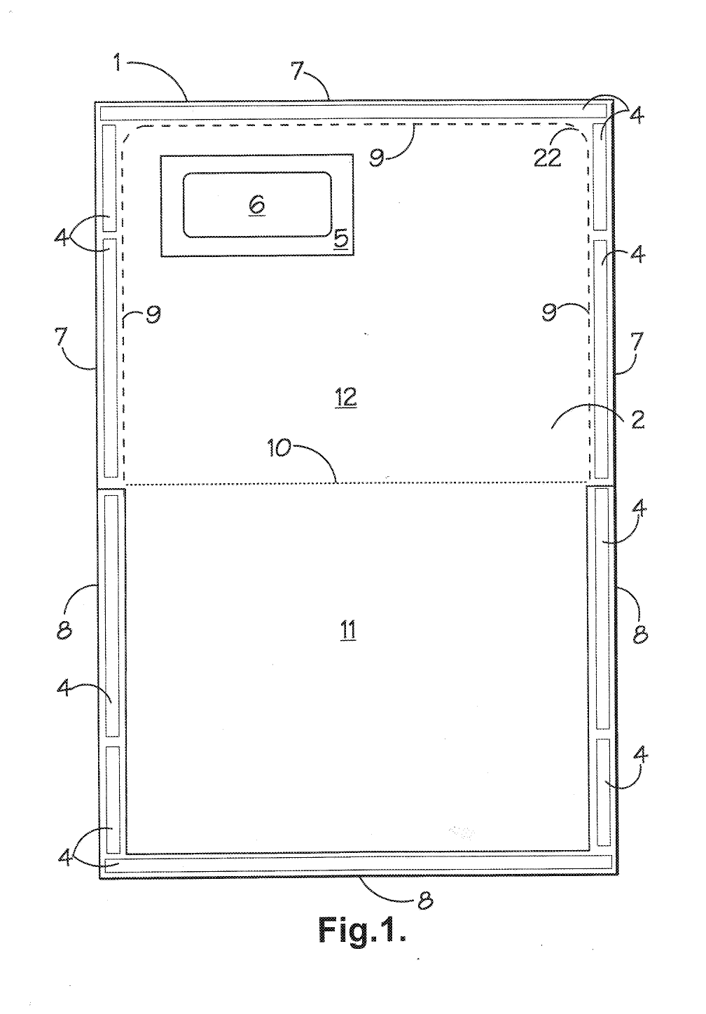

The figures illustrate a blank form 1 comprising a paper substrate with a window area 6, preferably die cut, over which is laid a transparent window film 5. The embodiment is equally applicable to a form 1 without a window.

The form 1 has two equal parts 11 and 12 and is intended to be folded along fold line 10, so that the surfaces of the two parts 11, 12 contact each other.

A pattern of cohesive is located in strips 4 around the outer edges of the blank form 1, i.e. around the three outer border edges 8 in the first part 11 and the three outer border edges 7 in the second part 12. When the form 1 is folded at centre line 10 the border edges 8 are adjacent border edges 7 and the respective areas of cohesive 4 contact each other and bond together so that the folded form 1 seals at its edges and becomes a mailing document. The properties of the cohesive 4 may be such that the seal is permanent or not permanent e.g. so that the mailing document can be peeled open again without damage to the paper substrate.

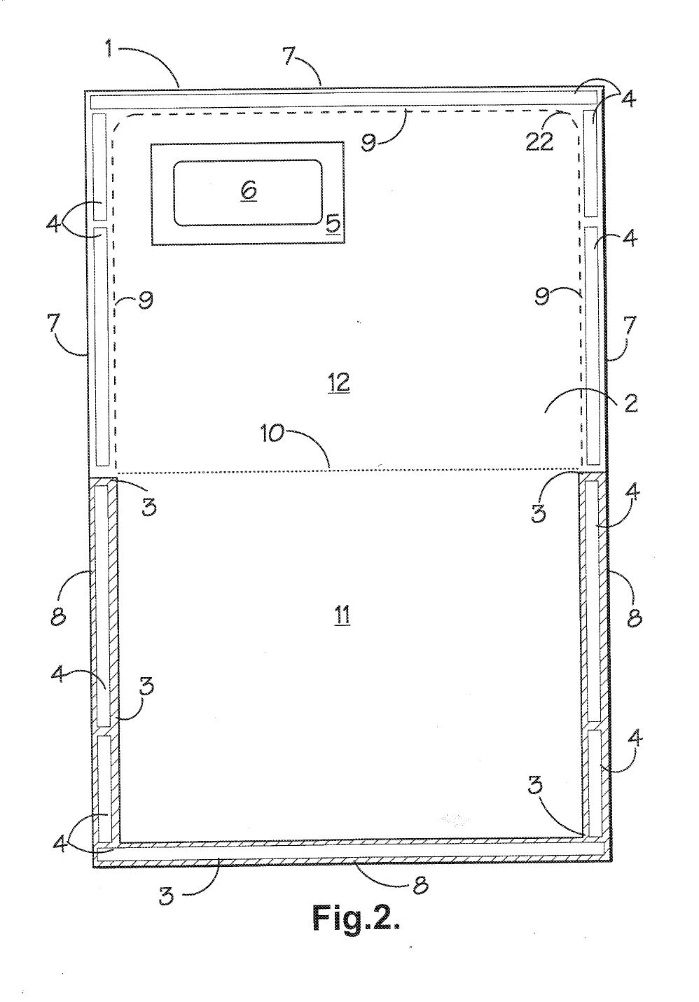

In the embodiment of FIG. 2 the peripheral border areas 4, adjacent to the outer border edges 8, on the first half 11 of the form, have a thin layer of an impermeable barrier 3 (shown in block shading) interposed between the strips of cohesive 4 and the paper substrate. This prevents the cohesive 4 penetrating the paper substrate on the first half 11 and hence if the sealed document is peeled open, the cohesive on the first half 11 peels away from barrier 3.

The barrier 3 may be formed of printer's varnish which is deposited on the paper by a printing process. Printer's varnish and processes to print varnish on documents are well known. For example printer's varnish is used to improve the appearance of high quality documents by making them appear “glossy”. It may also be used to make a document more hard wearing or to seal the printing on a document to prevent ink rubbing off or running or spreading. Printer's varnish can typically be applied using the same printing techniques and apparatus used for applying ink. Hence conventional methods of applying varnish include litho-printing and offset-litho printing techniques.

The varnish is then cured, i.e. dried, and the pattern of cohesive is applied over the varnish 3 and the remaining border areas as shown at 4.

A type of printer's varnish known as U-V varnish is particularly suitable for the embodiments because it only dries to the touch when exposed to ultra-violet light. Such varnish is dried by ultra-violet light before the pattern of cohesive is applied over the varnish as shown as strips 4 in the border edges 8 of the first part 11 of the form 1.

Either gloss or matt varnish may be used and gloss varnish allows the seal to be unpeeled more easily. Preferably a double layer of varnish is applied.

Alternatively the barrier 3 may be formed by a thin layer of liquid silicone instead of varnish. This is also cured before cohesive 4 is applied over the top.

A variety of other materials may be suitable as the barrier 3 provided they stick to or bind strongly with the paper substrate to decrease its porosity and prevent the overlying cohesive being in direct contact with the surface of the paper.

Cohesive is activated when two pieces of cohesive are brought together, as when the form is folded, and pressure is applied. A suitable such cohesive is available from producers such as National Starch & Chemical Co. in the UK or Henkel AG & Co. of Germany and an example of a suitable product is also described in U.S. Pat. No. 5,314,944.

Pressure may be applied by hand or the paper may be put through a machine to apply a more even and/or higher pressure and/or to increase productivity.

The cohesive may be chosen so that the paper does not seal together permanently even under a high pressure so that the folded and sealed document can be peeled apart to open it. This means that the opened document is intact and thus retains its original size, since it is not necessary to tear the border areas to open the document. The opened document thus has clean straight edges instead of the ragged ones produced by tearing, which makes the document easier to handle and file. There is also no peripheral tearing or disruption of the paper substrate such as that caused by the security slits of the prior art.

Perforations 9 are set around three internal edges of one half 12 of the sheet 1 to form a releasable or removable panel 2.

If the form 1 is peeled open, the cohesive 4 substantially peels away from the barrier 3, e.g. varnish, because the bond between the cohesive and the barrier 3 is weaker than the bond between cohesive and cohesive. Hence there will be no cohesive or very little cohesive left on the varnished side 11 of the opened form 1 and the form 1 cannot easily be resealed. It is thus evident to the recipient if the form 1 has been opened, or if any attempt has been made to open it before receipt, so the recipient is alerted if the form 1 has been tampered with and that confidential information may have been obtained from it without authorisation. In addition the opened form is non-tacky and thus does not stick to other paper and can hence be stacked or filed.

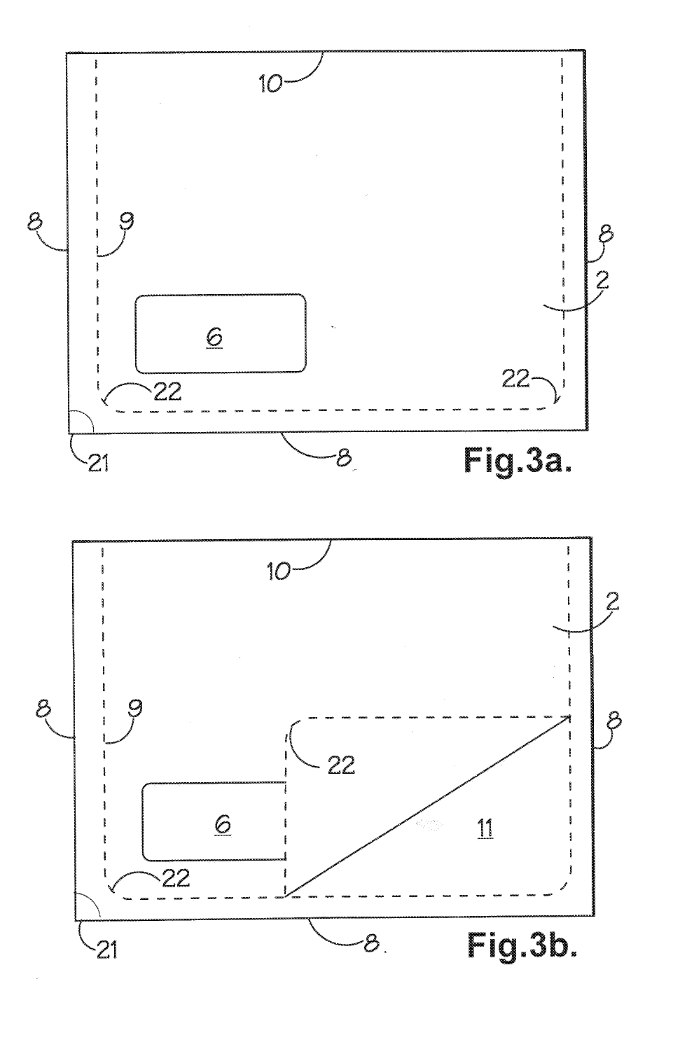

Perforations 9 are provided around three outer sides of the upper part 12 of the form 1. These perforations are positioned approximately 10 mm from the outer edges 8 of the upper part 12 and are so designed that they will release relatively easily by hand thus releasing a panel 2 in the upper part 12 and allowing the content of the form to be viewed with ease. This is illustrated in FIG. 3b which shows one corner of the panel 2 separated from the document along perforations 9 so that the content of the document is visible.

Preferably the cohesive pattern is formed in strips with small gaps 13 to facilitate the expulsion of air from within the folded document.

The fold line 10 may be pre-creased or perforated to make folding the form 1 easier so that the cohesive patterns 4 match accurately when the form is folded. The fold line 10 may also be perforated in such a manner as to allow removal of the panel from the form 1 without damage to the paper substrate.

The form 1 illustrated is a “V” fold form but the embodiments are equally applicable to “Z” and “C” fold forms. In the case of “C” or “Z” fold documents the areas covered by cohesive and by varnish would be adapted accordingly.

Information intended for the recipient, such as pay slip information, is printed on the lower half 11 of the form 1, and is then folded about centre fold line 10 and pressure is applied to seal the edges 8 to form a mailing document with the printed information inside.

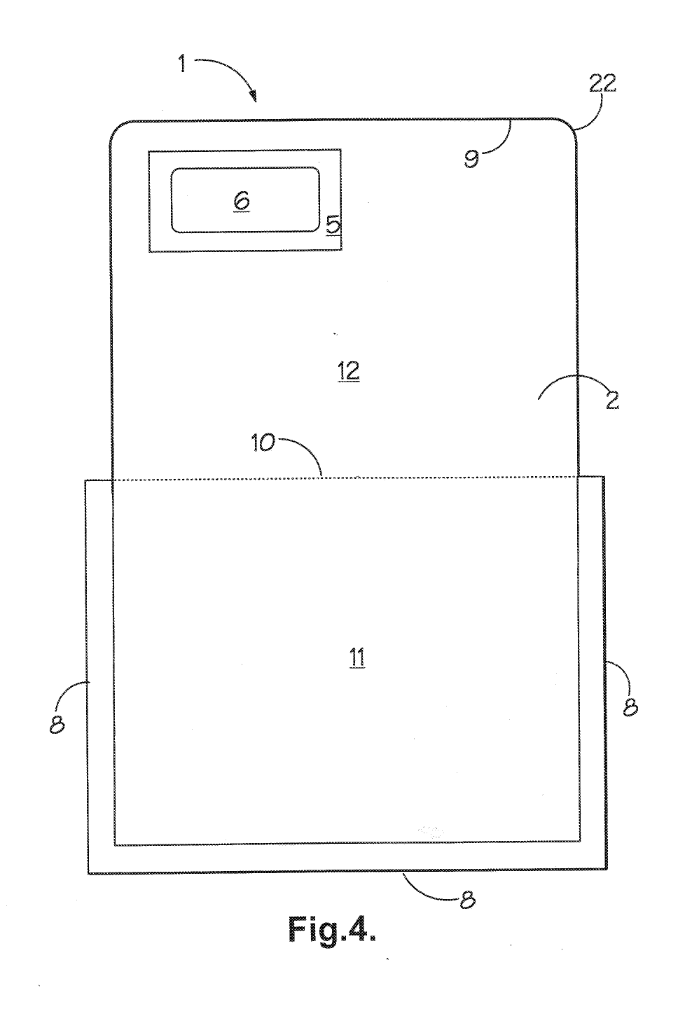

When a recipient receives the sealed form 1, the edges 8 can be peeled open to view the printed information. Preferably however the panel can be released by separating it at perforations 9 without damage to the paper substrate. Thus the whole opened document as shown in FIG. 4 can be filed away or the panel 2 can be detached along the centre line 10 and just the bottom half 11 retained for filing.

A small unsealed flap 21 (FIGS. 3a and 3b) could be provided in one corner of the blank form 1 and attention could be drawn to this by pre-printing words or symbols, so as to facilitate peeling open the sealed form.

The releasable panel 2, bordered by perforations 9, preferably has rounded or curved corners shown at 22 to resist tearing or damaging the paper substrate while it is being released.

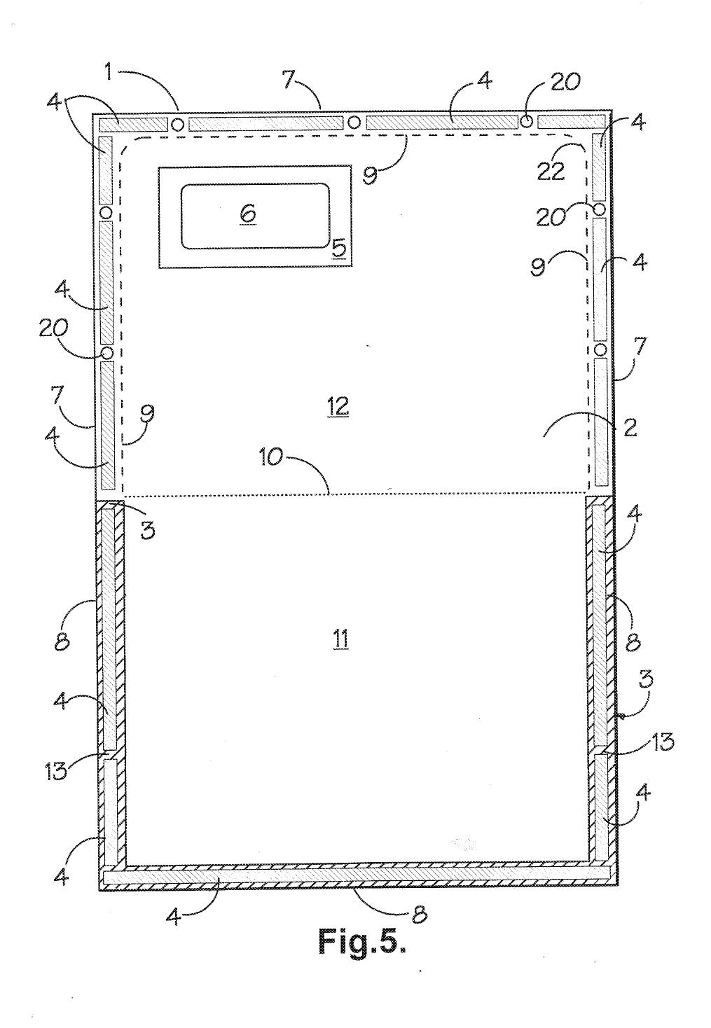

FIG. 5 illustrates another aspect in which the cohesive or adhesive is coloured or otherwise provided with means of visual contrast compared to the paper substrate. This is indicated by the cross hatched shading. On the upper part 12 of the form small holes 20 are punched at intervals between strips 4 of cohesive/adhesive. Thus in the folded sealed state the holes appear the same colour as the adhesive which shows through the holes. However when the form is then opened the cohesive/adhesive strips 4 peel off the varnish 3. If the form is then resealed there is no more coloured adhesive on the lower part 11 and the holes appear white (or the colour of the paper) thus alerting the recipient to a potential security breach.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments can be understood and effected by those skilled in the art in practicing the claimed disclosure, from a study of the drawings, the disclosure and the appended claims.

All references cited herein are incorporated herein by reference in their entirety. To the extent publications and patents or patent applications incorporated by reference contradict the disclosure contained in the specification, the specification is intended to supersede and/or take precedence over any such contradictory material.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Where a range of values is provided, it is understood that the upper and lower limit, and each intervening value between the upper and lower limit of the range is encompassed within the embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

What is claimed is:

1. A blank form for a mailing document, comprising:
a paper substrate having a first border area and a second border area;
adhesive located in one or both of the first border area and the second border area so positioned that when the form is folded the first border area contacts and bonds to the second border area; and
a releasable panel.

2. The blank form of claim 1, wherein the panel is configured to be manually releasable, and wherein at least one corner of the panel is curved to facilitate separation without tearing the paper substrate itself.

3. The blank form of claim 1, wherein the releasable panel comprises perforations around at least three sides within the border area, wherein the perforations are configured so that the panel can be separated from the border area on at least three sides by hand without tearing or otherwise damaging the paper substrate, so that the panel can be released or removed to allow a content of the form to be viewed.

4. The blank form of claim 3, wherein the perforations are formed by making cuts in the form separated by ties which are shorter than the cuts, so that the separated edges of the panel and the form are smooth.

5. The blank form of claim 4, wherein the number of cuts is 5 to one inch (2.54 cm).

6. The blank form of claim 4, wherein each of the cuts is between 5-7 mm long and wherein the cuts are separated by ties of 1 mm or less.

7. The blank form of claim 4, wherein the ties are between ¼mm and ¾mm.

8. The blank form of claim 3, wherein the releasable panel comprises perforations along four sides so that it is removable from the sealed form.

9. The blank form of claim 1, wherein the adhesive forms a permanent irreversible bond.

10. The blank form of claim 1, wherein the adhesive is a pressure seal adhesive configured to be sealable by machine pressure.

11. The blank form of claim 1, wherein the adhesive is a contact adhesive configured to be sealable by hand pressure.

12. The blank form of claim 1, wherein the adhesive forms a reversible bond and comprises a cohesive which bonds only with more cohesive, and wherein a barrier layer is interposed between the paper substrate and the cohesive in the first area, so that the cohesive in the first area is not in direct contact with the surface of the paper, and the cohesive in the second area is in direct contact with the surface of the paper, so that the sealed form is configured to be peeled open without damaging the substrate but is configured to not be easily re-sealed because the cohesive on the barrier layer is removed by the opening process.

13. The blank form of claim 12, wherein the barrier layer is varnish or liquid silicone and is applied in one or more layers by a printing process, and wherein the adhesive is applied by a printing process in thin, non-tacky layers.

14. The blank form of claim 1, wherein the releasable panel comprises a major portion of one of the first and second parts of the form, and the perforations are located relatively close to or adjacent the border areas so that when the panel is released, substantially the whole of the inside of the form can be viewed.

15. A method of making a blank form, comprising:
applying adhesive to a paper substrate in a border region along outside edges of the paper substrate; and
forming a manually releasable, or removable, panel in the substrate.

16. A mailing document formed from the blank form of claim 1, comprising any one of the following items: greetings correspondence, an advertisement, promotional material, a token, or a voucher.

17. A mailing document formed from the blank form of claim 16, wherein the greetings correspondence, advertisement, promotional material, token, or voucher is formed of at least part of the releasable or removable panel.

18. A mailing document formed from the blank form of claim 16, wherein at least one of the items is attached to the body of the document by adhesive or cohesive.

19. A mailing document formed from the blank form of claim 16 wherein at least one of the items is enclosed in the document as a loose unattached insert.

20. A blank form for a mailing document, the form comprising a paper substrate having a first part and a second part, each having a border region and a pattern of cohesive located in each border region, and a barrier layer in the first part interposed between the paper substrate and the cohesive pattern so that in the first part the cohesive is not in direct contact with the surface of the paper, and in the second part the cohesive is in direct contact with the surface of the paper, wherein the cohesive is of a contrasting colour compared to the paper substrate, and wherein at least one hole is located in the border region of one of the second part so that the contrasting colour is visible in the hole when the document is sealed.
